(19) United States
(12) Patent Application Publication
(10) Pub. No.: US 2009/0320928 A1
(43) Pub. Date: Dec. 31, 2009

(54) MULTI-TRACK ROTARY VALVE IN COMBINATION WITH A PRESSURE REDUCER AND METHOD FOR OPERATING THE COMBINATION

(75) Inventor: Robert J. L. Noe, Prospect, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(73) Assignee: UOP LLC, Des Plains, IL (US)

(21) Appl. No.: 12/165,170

(22) Filed: Jun. 30, 2008

(51) Int. Cl. F17D 1/00; F16K 11/02

(52) U.S. Cl. 137/12; 137/625.46

(57) ABSTRACT

A method for operating a multi-track rotary valve having plural tracks for the separate introduction to vessels of at least 3 feed streams and the separate recovery from the vessels of at least 3 product streams and for simultaneous change of the flow paths of the streams. At least one stream is selected and maintained at lower pressure than the other streams so that any leakage flows from the other streams to the at least one selected stream.

### FIELD OF THE INVENTION

The invention relates to a method for operating a multi-track rotary valve. In particular, the invention relates to a method for preventing leakage of at least one component stream into other component streams in the valve. The invention also relates to a multi-track rotary valve in combination with a pressure reducer.

### DESCRIPTION OF RELATED ART

Multi-port rotary valves are used in many processes that require simultaneous interconnection of plural conduits and simultaneous changes in those connections. In these processes, streams of fluids are routed in predetermined routes to achieve a particular result. These routes are changed in a predetermined time and are repeated frequently. Typically, these processes are multi-vessel processes in which a different process is carried out in each vessel. For example, a fluid may be purified in one vessel while a second vessel is regenerated with a second fluid and the second fluid is cleaned in a third vessel. Also, some refrigeration cycles utilize rotary valves to direct fluids to different processing vessels in turn.

For example, WO 2005/078363 discloses a three-track rotary valve for a Gifford McMahon-type pulse tube refrigerator. The valve allows passage of a working fluid from a compressor to and from regenerators and the coldhead. The valve includes a rotary valve disc and a valve seat.

U.S. Pat. No. 6,063,161 discloses a pressure swing adsorption process used for separation of a gas mixture having a plurality of adsorbent beds.

U.S. Pat. No. 7,276,107 discloses an indexing rotary valve that controls a variable feed inlet rate and a variable product outlet rate, together with regeneration, for a two-vessel pressure swing adsorption process.

U.S. Pat. No. 4,633,904 discloses a multi-port rotary valve for accommodating simultaneous interconnection of a plurality of conduits in accordance with a predetermined cycle. The valve comprises rotors having plural tracks, and when the rotors are rotated relative to each other, the tracks move to establish different flow paths for the plural fluid streams. The tracks and conduits are arranged to minimize hammer (hydraulic shock).

U.S. Pat. No. 6,004,518 is directed to a valve system for a high-purity simulated moving bed adsorptive separation apparatus. To maintain the purity of the products, selected valves are three-way valves designed to flush selected conduits.

U.S. Pat. No. 6,712,087 discloses a rotary valve assembly designed to prevent fluid stream contamination resulting from leakage from valve sections. The valve assembly includes a vent located between valve members containing tracks for directing the fluid streams. Leakage thus is directed to the vent, which is at a lower pressure than the pressures of the fluid streams.

Another vent-type arrangement for contaminant management in a rotary valve is disclosed in U.S. Pat. No. 7,160,367. In particular, seals between valve rotors are used, together with a breather that directs leakage away from the product streams. US 2007/0028971 discloses a vent for a sealed rotary valve that leads to a vacuum pump to prevent contamination of other streams.

As can be seen, multi-port rotary valves are important components in various processing schemes, and many ways of reducing contamination of streams have been proposed. However, solutions for this problem have, to date, involved additional hardware, such as seals, vents, and vacuum pumps. Thus, there exists a need for a method for dealing with contamination of streams in multi-port rotary valves, and to apparatus for carrying out the method.

### SUMMARY OF THE INVENTION

In a first embodiment, the invention is directed to a method for operating a multi-track rotary valve.

A second embodiment of the invention is directed to a method for preventing leakage of a stream in a multi-track rotary valve from contaminating other streams.

A third embodiment of the invention is directed to a method for preventing leakage from a stream in a multi-track rotary valve into other streams by selecting at least one stream and operating that stream at lower pressure than the other streams so that any leakage flows from the other streams into the at least one selected stream.

A fourth embodiment of the invention is directed to apparatus comprising, in combination, a multi-track rotary valve and a pressure reducer.

### DETAILED DESCRIPTION OF THE INVENTION

Contamination of fluid streams flowing through rotary valves is difficult to control. A number of approaches have been taken to prevent or control leakage in such rotary valves. However, the proposed solutions remain unsatisfactory in certain aspects. Therefore, embodiments of this invention are directed to a method for operating a multi-track rotary valve to prevent leakage in the valve from contaminating other streams. In a particular embodiment, at least one stream is selected to operate at a pressure lower than the pressures of the other streams. In this way, leakage from the other streams will flow from the other streams to the selected stream.

There are many instances in which it is necessary to route a fluid stream to one location for a period of time, then to another location for a period of time, and so forth for multiple locations. This relatively simple problem of routing a single fluid stream to various destinations in a previously determined cycle or periodic sequence is easily accomplished with one or more devices such as a multi-port rotary valve. When it is necessary to simultaneously route more than a single fluid stream to various destinations, it is highly desirable to use a single device rather than numerous individual valves. Thus, rotary valves are used in many processes in which process steps are taken repeatedly and in a predetermined pattern.

Rotary valves are widely used in the process industries for directing fluids from one or more process sources to one or more process destinations in repeatable cyclic process steps. These valves are used in cyclic or repeatable processes such as gas separation by pressure (pressure swing adsorption) or temperature swing adsorption, liquid separation by concentration swing adsorption, gas or liquid chromatography, regenerative catalytic processes, pneumatic or hydraulic sequential control systems, and other cyclic processes.

For example, cyclic adsorption processes are generally practiced in batteries of adsorption vessels comprised of two or more adsorbent-filled vessels arranged in parallel and operated out of phase such that at least one vessel is in the adsorption mode while at least one other vessel is in the adsorbent regeneration mode. In each cycle of the process, a series of sequential steps, including adsorption, equalization and regeneration, are carried out in each vessel. To enable the various streams to flow to and from the vessels, the feed, product, and exhaust lines must be provided with valves to permit gas flow through these lines at the appropriate time in the adsorption cycle. Furthermore, cross-connecting lines must be provided between the inlet ends of the vessels and between the outlet ends of the vessels to permit flow between the vessels during pressure equalization steps, and each cross connecting line must be equipped with a valve to control the flow of gas through these lines.

Pressure swing adsorption (PSA) and vacuum pressure swing adsorption (vacuum-PSA) separate gas fractions from a gas mixture by coordinating pressure cycling and flow reversals over an adsorbent bed which preferentially adsorbs a more readily adsorbed component relative to a less readily adsorbed component of the mixture. The total pressure of the gas mixture in the adsorbent bed is elevated while the gas mixture is flowing through the adsorbent bed from a first end to a second end thereof, and is reduced while the gas mixture is flowing through the adsorbent from the second end back to the first end. As the PSA cycle is repeated, the less readily adsorbed component is concentrated adjacent the second end of the adsorbent bed, while the more readily adsorbed component is concentrated adjacent the first end of the adsorbent bed. As a result, a “light” product (a gas fraction depleted in the more readily adsorbed component and enriched in the less readily adsorbed component) is delivered from the second end of the bed, and a “heavy” product (a gas fraction enriched in the more strongly adsorbed component) is exhausted from the first end of the bed.

In this process, the light product is usually the desired product to be purified, and the heavy product often a waste product, as in the important examples of oxygen separation over nitrogen-selective zeolite adsorbents and hydrogen purification. The heavy product may be a desired product, as in the example of nitrogen separation over nitrogen-selective zeolite adsorbents. Typically, a feed fluid is admitted to the first end of an adsorber and light product is delivered from the second end of the adsorber when the pressure in that adsorber is elevated to a higher working pressure. Heavy product is exhausted from the first end of the adsorber at a lower working pressure. In order to achieve a higher purity light product, a fraction of the light product or gas enriched in the less readily adsorbed component is recycled back to the adsorbers as “light reflux” gas after pressure letdown, e.g. to perform purge, cocurrent blowdown, pressure equalization, or repressurization steps. Therefore, it is necessary to coordinate flow of this light reflux gas together with the other streams.

In particular, the need for high purity (>99.9%) hydrogen is growing in the chemical process industries, e.g., in steel annealing, silicon manufacturing, hydrogenation of fats and oils, glass making, hydrocracking, methanol production, the production of oxo alcohols, and isomerization processes. This growing demand requires the development of highly efficient separation processes for H₂ production from various feed mixtures.

A typical H₂-containing feed gas contains several contaminants, such as CO₂ (20% to 25%) and minor amounts of H₂O (<0.5%), CH₄ (<3%), CO (<1%) and N₂ (<1%). Such a combination of adsorbates at such widely varying compositions presents a significant challenge to efficient adsorbent selection, adsorbent configuration in the adsorber, and the choices of individual adsorbent layers and multiple adsorbent bed systems to obtain an efficient H₂—PSA process.

Thus, efficient and effective valving is important. Using fewer valves and faster PSA cycles, i.e., shorter cycle times, leads to significant reduction in adsorbent inventory and PSA system cost. Rotary valves are ideally suited for fast PSA cycles and compact PSA systems. In the application of rotary valves in the PSA systems, the rotary valve devices must accommodate the communication between feed inlet ends and product outlet ends of a PSA system as well as for allowing the flow between beds during pressure equalization step(s) of the process. Pressure equalization normally occurs by transferring a gas from one bed that has just completed its adsorption step to an evacuated bed that has just completed its adsorbent regeneration step.

Another exemplary PSA embodiment is oxygen enrichment of air using nitrogen-selective adsorbents, which are hydrophilic in their activated condition. Gas separation by pressure swing adsorption is achieved by synchronized pressure cycling and flow reversals over an adsorber that preferentially adsorbs a more readily adsorbed component relative to a less readily adsorbed component of the feed gas mixture. The total pressure is elevated during intervals of flow in a first direction through the adsorber from a first end (feed end) to a second end of the adsorber (product end), and is reduced during intervals of flow in the reverse direction. As the cycle is repeated, the less readily adsorbed component is concentrated in the first direction, while the more readily adsorbed component is concentrated in the reverse direction.

In this process, problems are caused by other, even more preferentially adsorbed components in the process gases or in the surrounding atmosphere, such as ambient water vapor or another vapor contaminant, whose very strong and sometimes almost irreversible adsorption may deactivate or poison the adsorbent to degrade its capacity and selectivity for the primary separation function. Thus, it is necessary to maintain the purity of the streams and to control leakage.

Rotary valves with a flat rotating circular seal configuration are particularly useful in pressure swing adsorption (PSA) systems utilizing multiple parallel adsorber beds operating in overlapping cyclic steps which include feed, pressure equalization, depressurization, purge, and repressurization steps. In a typical application, a stator having multiple ports is used to connect feed gas and waste gas lines with the feed ends of a plurality of adsorber beds and also to connect the product ends of the beds with a product line and to connect the product ends of pairs of beds for pressure equalization. A rotor having multiple ports sealably rotates on the stator such that the openings on the stator face register sequentially with openings in the rotor face as the rotor rotates to direct gas flow for the desired PSA process cycle steps.

A widely-used type of rotary valve has a planar circular configuration in which a flat ported rotor rotates coaxially on a flat ported stator such that ports in the stator and rotor are aligned or blocked in a predetermined cyclic sequence. Sealing typically is provided by direct contact of the flat rotor face sliding over the flat stator face. A high degree of precision is required in the fabrication of these flat surfaces to prevent excessive leakage at the mating surfaces. Rigid materials such as metal, carbon, or ceramic typically are used for rotors and stators, but wear of the parts or distortions caused by temperature differentials may cause changes in the shape of the surfaces, thereby allowing leakage across the seal formed between the surfaces.

In a typical PSA cycle, the internal passages of a rotary valve are at different pressures as the PSA cycle proceeds. If there is leakage between ports at different pressures, cross-contamination may occur, which in turn can reduce PSA performance parameters such as product purity and product recovery. Internal leakage among valve ports connected to the product ends of the beds is undesirable, because contaminants in the product ends of the beds can affect product purity. When the PSA cycle includes regeneration and purge steps under vacuum, the pressure differentials across the valve sealing face, particularly between rotor and stator ports connecting the feed and product ends of the beds, may lead to various operating problems if leaks occur between these ports.

These rotary valves require dynamic sealing surfaces, some of which define the boundaries of process gas system containment and sometimes the ambient surroundings. Because of the relative motion of the moving surfaces, a tight fluid seal is not practicable, and some mass flow of components in the surrounding ambient gas or other process gas into the light gas is possible, even if there are pressure gradients opposing these mass flows across the dynamic seals.

Other adsorptive processes also utilize multi-port rotary valves. For example, simulated moving bed (SMB) adsorptive separation is used commercially in a number of industries to perform useful separations of a variety of chemicals including petrochemical intermediates. It is established as a leading industrial process for the recovery of para xylene suitable for the production of polyesters. It is also a leading process for the recovery of normal paraffins used in the production of linear olefins as detergent precursors. Adsorptive separation may also be suitable for separations of a wide variety of chemicals including chiral compounds and intermediates used in the production of experimental and therapeutic drugs. These efforts are normally conducted in small scale pilot plants which do not require much feed stock, adsorbent or plant space. This is especially true when the materials which are to be separated are expensive due to their rarity or complicated production techniques.

Although the general theory and operation of a simulated countercurrent moving bed (SMB) unit does not change as its design feed rate is decreased, pilot plant scale simulated moving bed adsorptive separation units have unique problems compare to industrial scale plants. Many of these problems are related to the higher level of product purity required for pharmaceuticals, the higher pressures used in HPLC and other factors specific to a separation rather than the overall SMB process. For instance, SMB pilot plants have been troubled by a need to achieve very high levels of separation between chiral compounds which have different pharmaceutical effects.

The separation of various substances through selective absorption using a simulated moving bed of adsorbent is an example of a process in which a multiport rotary disc valve is useful. In accomplishing this simulation, it is necessary to connect a feed stream to a series of beds in sequence, first to bed no. 1, then to bed no. 2, and so forth for numerous beds, the number of beds often being between 12 and 24. These beds may be considered to be portions of a single large bed whose movement is simulated. Each time the feed stream destination is changed, it is also necessary to change the destinations (or origins) of at least three other streams, which may be streams entering the beds, such as the feed stream, or leaving the beds. The moving bed simulation may be simply described as dividing the bed into a series of fixed beds and moving the points of introducing and withdrawing liquid streams past the series of fixed beds instead of moving the beds past the introduction and withdrawal points.

Further, there are many different process requirements in moving bed simulation processes, resulting in different flow schemes and thus variations in rotary valve arrangement. For example, in addition to the four basic streams (feed stock, raffinate, sorbent, and displacing agent), it may be desirable to utilize one or more streams to purge, or flush a pipeline or pipelines. A flush stream is used to prevent undesirable mixing of components. The flush substance is chosen to be one which is not undesirable for mixing with either main stream, that being purged or that which enters the pipeline after flushing is completed. It may be desirable to pass fluid through a bed or beds in the reverse direction from normal flow. This is commonly known as backflushing.

The pharmaceutical industry requires very high levels of purity and therefore cannot tolerate backmixing of feed and product components in the mechanical arrangement used for simulating moving bed chromatographic separations. Specifically, transfer lines should not commingle streams by transporting both the feed and the effluent streams and valve leakage must be minimized compared to common petrochemical separations. It is a primary objective of the invention to provide an apparatus for performing simulated moving bed separations which is capable of producing very high purity products.

Multi-port rotary valves are, therefore, important in these processes. However, rotary valves have a known tendency to leak and otherwise cause contamination of ‘clean’ streams with ‘dirty’ material.

A multi-track rotary valve assembly includes a rotary member (rotor) and a static member (stator) relatively rotatable about a common center of rotation to provide valving action for selectively transferring fluids therethrough. Tracks, or paths, through the rotor direct the fluids to different sets of pre-selected pipes upon rotation.

Embodiments of this invention are directed to processes having at least three feed streams being separately introduced into vessels and three product streams separately recovered from the vessels. Simultaneous change of the flow paths of such streams is particularly suited for application of a rotary valve.

In accordance with an embodiment of the invention, at least one of the feed streams will be selected for introduction to the valve at a pressure lower than the pressure of other streams. In this way, any leakage in the valve from the higher-pressure streams will be recovered in the lowest-pressure stream. Recovery of leakage in a fluid stream is environmentally preferable to venting leakage into the atmosphere.

In accordance with another embodiment of the invention, the selected lowest-pressure stream is arranged so that the track through which the selected lowest-pressure stream flows is between two higher-pressure streams. This spatial arrangement helps ensure that leakage of one stream will not flow to the other stream, but rather will flow to the lowest-pressure stream.

Another embodiment of the invention is directed to apparatus comprising a rotary valve in combination with a device that reduces the pressure of the selected lowest-pressure stream. Such devices include valves, restriction orifices or plates, baffles, and other fittings.

Typically, as described above, a process amenable for use of a rotary valve processes a feed stream to adsorb a desired composition and yield a raffinate. In turn, a desorbent is fed to the vessel to desorb the absorbed composition in the first vessel, producing an extract stream, while the feed stream now is directed to the second adsorption vessel.

Preferably, contaminants are precluded from being introduced to each of these streams. The product, or extract, stream contains the product sought. The raffinate, depleted of product separately recovered, can be further processed to create more of this product, and so preferably is kept contaminant-free. Desorbent must maintain its purity to preclude introduction of contaminants into the vessels, then to the product, during the desorption/extraction phase. The feed stream also should be protected from contaminants.

However, additional streams typically are used in these processes. In particular, additional streams are used to flush lines and rotary valve tracks between flow path changes to ensure highest purity of product and to reduce contamination of other streams, such as desorbent. Such flush streams are candidates for selection as the stream to be adjusted to have the lowest pressure in the valve. An advantage of changing the pressure on a flush stream is that such a change does not disrupt operating pressures in the vessels, which often are established to ensure optimal processing conditions.

In an embodiment of the invention, a flush stream is selected to operate at lower pressure than the other streams. Such a stream preferably is selected as the lower pressure stream because it is the lowest value stream. Preferably, a selected flush stream is one that is not introduced into a vessel. Using such a stream thus significantly reduces the likelihood that contaminants will be introduced into a vessel. A flush stream that is used to flush a line into a vessel can be used, but is not a preferred choice.

In other embodiments of the invention, the stream selected to operate at lower pressure is a stream from which any leaked components can be easily recovered. Alternatively, the lower-pressure stream is a stream that, even when contaminated with leakage, is easily disposed of in an environmentally responsible manner. With the guidance provided herein, it will be a straightforward matter for the skilled practitioner to select a stream to be introduced to the rotary valve at a pressure lower than the pressures of other streams.

In an embodiment of the invention, a flush stream is interposed into a track between streams that preferably are not to be contaminated, as described above, and is operated at lower pressure than either of the adjacent streams. If necessary, a track for such a flush stream is added to the rotary valve.

As described above, another embodiment of the invention is directed to apparatus comprising a multi-track rotary valve in cooperation with a device that reduces the pressure of the stream selected. In a particular embodiment, the pressure is reduced by interposing a restriction orifice into the rotary valve inlet port to reduce the pressure of the selected stream.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I claim:

1. A method for operating a multi-track rotary valve having plural tracks for the separate introduction to vessels of at least 3 feed streams and the separate recovery from the vessels of at least 3 product streams and for simultaneous change of the flow paths of the streams,
said method comprising selecting at least one stream and operating that stream at lower pressure than the other streams so that any leakage flows from the other streams to the at least one selected stream.

2. The method of claim 1, further comprising arranging the tracks so that the track in which at least one selected stream is flowing is between the tracks in which the other streams flow.

3. The method of claim 1 wherein at least one selected stream is the lowest-value stream flowing through the valve.

4. The method of claim 3 wherein the lowest-value stream is a flush stream.

5. The method of claim 1 wherein the at least one selected stream is not introduced into a vessel.

6. The method of claim 1 wherein the at least one selected stream is a stream from which leakage is recoverable.

7. The method of claim 1 wherein the at least one selected stream is a stream that, when contaminated with leakage from other streams, can be disposed of in an environmentally-sensitive manner.

8. The method of claim 2 wherein at least one selected stream is the lowest-value stream flowing through the valve.

9. The method of claim 8 wherein the lowest-value stream is a flush stream.

10. A method for preventing contamination of streams in a multi-track rotary valve having plural tracks comprising selecting at least one stream and operating that stream at lower pressure than the other streams so that any leakage flows from the other streams to the at least one selected stream.

11. The method of claim 10, further comprising arranging the tracks so that the track in which at least one selected stream is flowing is between the tracks in which the other streams flow.

12. The method of claim 10 wherein at least one selected stream is the lowest-value stream flowing through the valve.

13. The method of claim 12 wherein the lowest-value stream is a flush stream.

14. The method of claim 10 wherein the at least one selected stream is not introduced into a vessel.

15. The method of claim 10 wherein the at least one selected stream is a stream from which leakage is recoverable.

16. The method of claim 10 wherein the at least one selected stream is a stream that, when contaminated with leakage from other streams, can be disposed of in an environmentally-sensitive manner.

17. The method of claim 11 wherein at least one selected stream is the lowest-value stream flowing through the valve.

18. The method of claim 17 wherein the lowest-value stream is a flush stream.

19. Apparatus for reducing contamination of pre-determined streams by other streams in a rotary valve having a plurality of tracks through which each stream flows separately comprising a rotary valve and a pressure-reducing device at the entry port for one of the other streams.

20. The apparatus of claim 19 wherein the pressure-reducing device is a restriction orifice.
